(19) United States
(12) Patent Application Publication
(10) Pub. No.: US 2010/0262440 A1
(43) Pub. Date: Oct. 14, 2010

(54) AUTOMATED RESERVATION AGENT

(75) Inventor: Scott J. Ulring, Minneapolis, MN (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(73) Assignee: STONE ARCH BRIDGE GROUP, Minneapolis, MN (US)

(21) Appl. No.: 12/726,756

(22) Filed: Mar. 18, 2010

Related U.S. Application Data
(60) Provisional application No. 61/212,467, filed on Apr. 13, 2009.

(51) Int. Cl. G06Q 50/00; G06Q 10/00; G06Q 30/00; G06F 17/30

(52) U.S. Cl. 705/5; 455/466; 704/260; 704/235; 455/415; 705/10; 707/706; 707/E17.108

(57) ABSTRACT

In a method consistent with the technology disclosed herein, the system receives a text message from a mobile phone and parses the text message into at least a first data field and a second data field, where the first data field is a start date for the service, and the second data field is an end date for the service. The service is then booked from the start date to the end date.

This application is a non-provisional application claiming priority to U.S. Provisional Application No. 61/212467 filed Apr. 13, 2009, and the entire contents of the U.S. Provisional Application are incorporated herein by reference.

### FIELD OF THE INVENTION

The technology disclosed herein generally relates to systems and methods for booking reservations. More particularly, the technology disclosed herein relates to an automated reservation agent.

### BACKGROUND

Online booking processes are ubiquitous. For hotels, online booking methods have taken basic, historical reservation practices and ported them into online systems. One innovation that online methods introduced is that is allowed the traveler to expand the aperture of his or her search like a travel agent would, in so doing the end customer gained access to online inventory systems to search multiple hotels for the same date. Doing so simplified the process of shopping multiple hotels but dramatically increased the inquiries generated for a confirmed booking. Competition in the online space has led to rate flattening. As a result, the payoff for investing time shopping multiple hotels online has diminished. Today with lowest rate guarantees, travelers are assured that the published rate posted by their favorite hotels will be competitive. The hotel's ability to stratify rates for different categories of travelers has diminished. With these changes we believe a new set of methods that operate on fundamentally different principles will increasingly be beneficial.

### SUMMARY OF THE INVENTION

In one embodiment of the technology disclosed herein, a booking system has a text parse engine that is configured to receive a text message containing information related to a desired reservation and parse the text message into a plurality of fields. A search engine interface is configured to receive data from the text parse engine and be in communication with a booking database reflecting available reservations. Also, a processor is in communication with the text parse engine and the search engine interface, wherein the processor is configured to reply to the text message with information related to one of the available reservations.

In a method consistent with the technology disclosed herein, the system receives a text message from a mobile phone and parses the text message into at least a first data field and a second data field, where the first data field is a start date for the service, and the second data field is an end date for the service. The service is then booked from the start date to the end date.

In yet another embodiment of the technology disclosed herein, a system receives a text message from a mobile phone and parses the text message into at least an offer data field, wherein the offer data field is an offer rate for a service. The difference between the offer rate and a best available rate is calculated and a probability incorporating the difference between the offer rate and the best available rate is determined. The probability is applied to a decision to accept or decline the offer rate, and a text message response reflecting the decision is sent to the mobile phone.

### BRIEF DESCRIPTION OF THE DRAWINGS

The invention may be more completely understood and appreciated in consideration of the following detailed description of various embodiments of the invention in connection with the accompanying drawings.

FIG. 1 depicts a method in accordance with the technology disclosed herein for building a service provider database.

FIG. 2 depicts another method in accordance with the technology disclosed herein.

FIG. 3A depicts a first example sub-method of the method depicted in FIG. 2 in accordance with the technology disclosed herein.

FIG. 3B depicts a second example sub-method of the method depicted in FIG. 2 in accordance with the technology disclosed herein.

FIG. 3C depicts a third example sub-method of the method depicted in FIG. 2 in accordance with the technology disclosed herein.

FIG. 4 depicts an example system in accordance with the technology disclosed herein.

FIG. 5 depicts an example implementation of the technology disclosed herein.

### DETAILED DESCRIPTION

The system described herein can be used in a variety of industries for booking services, making appointments, and the like, through a relatively straightforward system allowing a user to text message pertinent data to the system that is used to meet the needs of the user. Various details regarding both the users and the businesses can be stored in one or more databases for future access and use by the system. This minimizes the number of transactions or communications required to achieve a successful reservation.

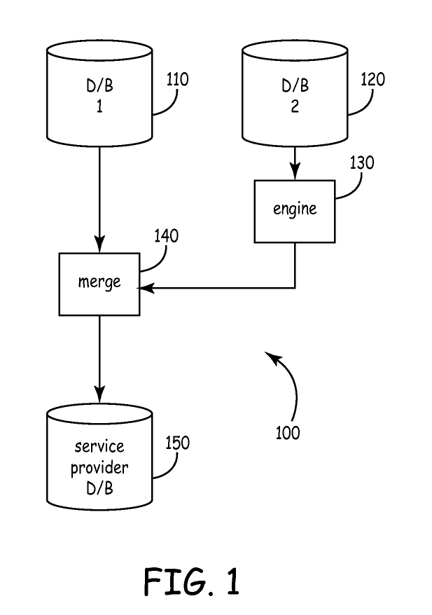

FIG. 1 depicts a method in accordance with the technology disclosed herein for building a service provider database. In a variety of embodiments of the current technology, at least one primary database is created of reference codes, numbers, names, and the like, to identify service providers. Service providers can be identified by one or more characteristics including location, brand, name, price range, level of service, and the like. In various situations it can be desirable to use multiple characteristics. In one example, the service provider is identified by name and location, where the location is represented by one or more local airport codes. In another embodiment, the service provider is identified by name and location, where the location is represented by a zip code or postal address. In another embodiment, the service provider is identified by a name and location, where the location is represented by a city name.

The services provided by the service providers can be relevant to hotels, salons, air travel, vehicle rentals, cruises, tours, vacation ownership systems, bed & breakfasts, classes, restaurants, and any other type of service. The technology disclosed herein will be described primarily in the context of hotels, but one of ordinary skill in the art will understand that such technology can be applied to a variety of business models and service providers.

The first database 110 contains a list of a possible characteristic of a service provider, and the second database 120 contains a second list of a possible characteristic of a service provider. In the context of the example above, the first database 110 can contain particular service provider locations represented by airport codes or city name and country code, while the second database 120 can contain particular service provider names. The combination of the two characteristics can be used to identify at least one particular service provider. The information contained in the first database and the second database can be merged 140 to create a service provider database 150. The service provider database 150 contains a list of service providers identified by name and location, where the location is represented by an airport code or by a combination of airport code, city and country.

It may be desirable to abbreviate or otherwise shorten the name of one of the characteristics of the service provider, such as abbreviating the name of a hotel. In such an instance an engine 130 can be used to convert information in the second database into the desired format, and the output of the engine 130 can be merged 140 with data from the first database to create the booking service provider database 150. The resultant booking service provider database 150 uniquely identifies each service provider by name and location, where the name is abbreviated and includes both brand and location name and the location is represented by an airport code. In another embodiment, the location is represented by the service provider zip code. In an additional embodiment, the location is represented by the service provider area code.

The combination of name and location can be referred to as a “booking handle” that can simply be a means to identify a particular service provider. In some embodiments, the booking handle can be associated with a variety of characteristics of the service provider that is also stored in the booking database including website, e-mail, phone number, and the like. In another set of embodiments, the booking handle is merely associated with the full name and location of the service provider in the database. In at least one embodiment booking handle is data that is maintained by the system but published and made available to users for use with the system.

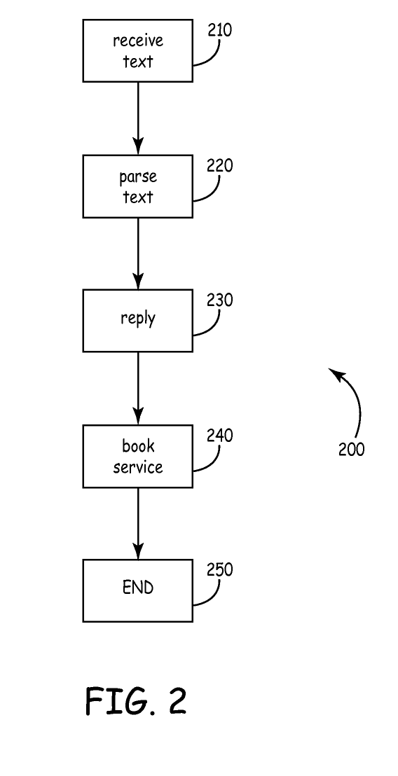

FIG. 2 depicts a method in accordance with the technology disclosed herein for enabling mobile phone users using standard text messaging formats to perform a basic search for service providers.

In at least one embodiment a mobile phone user can input and send, as a text message, a check-in date and a check-out date, or simply an arrival date or service start date. In another embodiment a mobile phone user can input a start time and an end time. In a variety of embodiments the mobile phone user can also input the location of the service provider. In such a scenario, the mobile phone user can provide the location of the service provider represented by an airport code, a zip code, a postal address, or other representations of a location like booking handle. The input of the mobile phone user can depend on the type of service providers being searched, and/or the type of search being conducted.

The text message provided by the mobile phone user is unstructured in at least one embodiment. The system receives the text message 210 from the mobile phone of the mobile phone user and parses the text message 220 into at least a first data field and a second data field. For example, the first data field is a start date for the service and the second data field is an end date for the service. The system can additionally parse the text message 220 to include a third data field. Such third data field can be information indicative of the location of the service provider, such as an airport code. The system can also parse specific postal addresses and return proximate service providers in one embodiment.

After parsing the text message 220, the system can reply 230 to the mobile phone user based on a determination of the availability of the service. The system itself may determine availability of the service in at least one embodiment, but in a variety of embodiments the system receives availability data from another source. The availability of the service, however, is determined based on at least the first data field and the second data field. In at least one implementation, determining the availability of a service is based on the first data field, the second data field, and the third data field.

The reply 230 to the mobile phone generally includes communication to the mobile phone user regarding service availability. The reply 230 to the mobile phone user can also include one or more booking options and solicit acceptance for one of the booking options. The reply 230 to the mobile phone user also can include price information, such as the best available rate in a particular location where service is sought or from a particular service provider. At least one particular embodiment includes the best available rate from a particular service provider and the best available rate from a competing service provider, where the competing service provider is determined based on factors such as relative location, rating, level of service, customer preference, or any other factor determined to be relevant. The particular service provider can be a service provider chosen by the mobile phone user and indicated in their initial text message to the system, for example, or in a user account previously established, in another example. In a variety of embodiments, the reply 230 includes availability information based on the service provider most recently booked through the system for the particular user, which is determined based on the phone number of the user. As such, in multiple embodiments the system incorporates caller identification technology to identify user phone numbers and uses phone numbers to identify past service inquiries from the particular phone number.

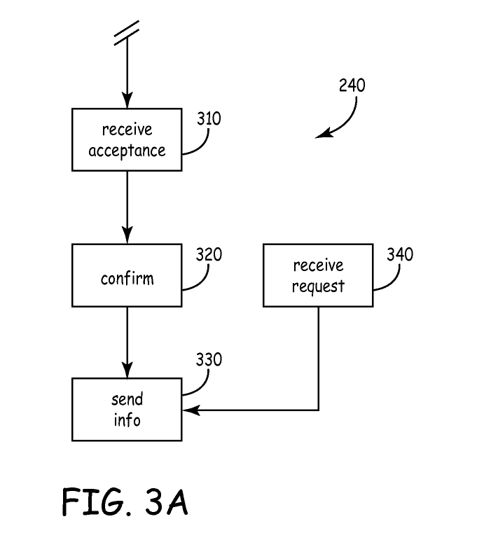

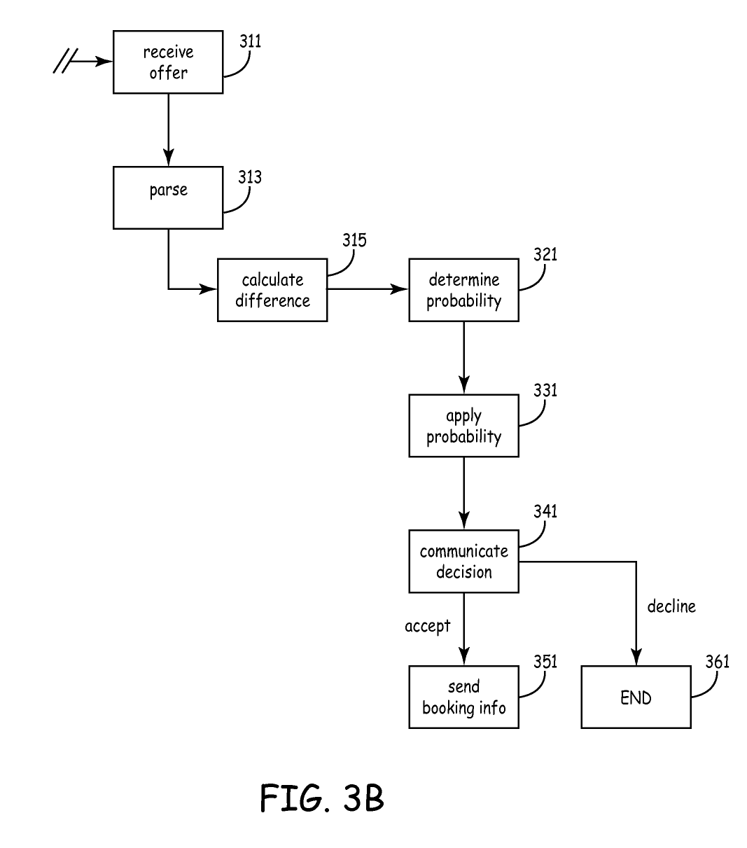

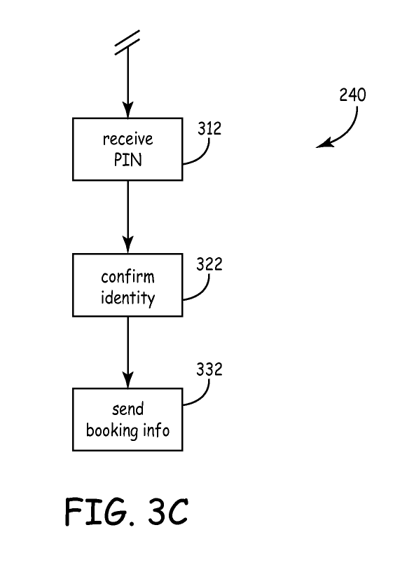

Replying 230 to the mobile phone user with availability data can lead to booking the service 240, at which point the process ends 250. The method of booking the service 240 depicted in FIG. 2 can have a variety of implementations that are consistent with the technology disclosed herein. FIGS. 3A, 3B, and 3C depict different sub-methods incorporated in “booking the service” 240 of FIG. 2, in accordance with the technology disclosed herein.

In the method depicted in FIG. 3A, the system can then receive acceptance 310 through a text message from the mobile phone user, where the mobile phone user indicates acceptance of one of the one or more booking options. The one or more booking options can be numbered, for example, such that acceptance of one of the one or more booking options is indicated through sending a text to the system containing the number of the chosen booking option. Other approaches can also be used to identify and communicate a particular booking option to the system.

The system then confirms the booking 320. In one embodiment the system confirms the booking 320 by soliciting a confirmation text message from the user, and receiving a text message confirming acceptance from the user. Generally, a confirmation text message from a user includes the mobile phone user signaling to the system an intention to book the service. Confirmation can include affirmative language such as “yes” or “okay,” or can include information provided by the user that can be used for booking the service, such as a personal identification number, credit card number, system handle and/or password, or other identification means. In another embodiment, the system uses user-provided information to confirm the booking, such previously provided user information from a previously-booked service or credit card information provided by the user.

In at least one embodiment the system may present a single booking option. In such a scenario the step of receiving acceptance 310 is not included, and the system simply confirms 320 booking of the only presented option with an “OK” from the user.

Once the booking is confirmed 320, the system sends booking information 330 to the service provider that provides the service. In one implementation the system sends booking information 330 to the service provider. In another implementation the system sends request information 330 to a service provider after having received a request 340 from the mobile phone user to, for example, communicate with the service provider, or communicate some other type of request. The user can send requests through text messages containing specific, system-known commands to speak with a live agent of the service provider at the local property or office of the service provider. In a variety of embodiments the system sends information 330 to the service provider through a text message.

The text message can be translated to a voice request, in at least one embodiment, where the voice request provides the information to the service provider through a telephone line. The system can use the text message itself, to identify the specific service provider, obtain service provider contact information from a database, such as the booking database disclosed in the discussion of FIG. 1, and automatically dial the specific service provider. Such an implementation can use standard text-to-voice translation functionality known in the art.

The system can send a text message 330 to the service provider to notify them of the booked service, request the service provider contact the mobile phone user, and/or provide other information to the service provider. In the embodiment shown, the system can send a text message to the service provider 330 in response to receiving a request 340 from the mobile phone user to connect the mobile phone with an agent of the service provider. The request 340 can be a text message. Also in the embodiment shown, the system can send a text to the service provider 330 either in response to, or in conjunction with, booking the service 240 for the mobile phone user. The text message 330 can include booking information, such as credit card information, mobile phone user name and address, and so on. The system can additionally be outfitted to convert the text messages send to the service provider 330 to a voice message, as the service provider may not be equipped to receive text messages. The voice message can also include prompts for a local customer service representative (CSR). The prompts allow the CSR to hold message delivery while the CSR, for example, pulls up the customer profile and then prompt again to accept message delivery.

In one embodiment the system books 240 the service using information from a previously-booked service by a particular mobile phone user. The previously-booked service can be a last-booked service, a last-used service, or a last inquired-about service. In at least one embodiment the previously-booked service is a prior service booked by the mobile phone user. In a variety of implementations information can be used from the mobile phone user's previously-booked service, and automatically applied to the mobile phone user's currently-sought service. Such information can include credit card data, billing address, phone number, customer number, service provider, service provider location, service, and so on.

The system can send a text message to the user that contains the best available rate. The user can accept the rate by replying with an affirmative response, such as “OK” or “yes.” A service provider that employs the system disclosed herein could have access to customer profiles in a database. The system can identify a previous system user by their mobile phone number, e-mail address and credit card number. Combinations of portions of this type of information can be used to allow a user to confirm their identity without having to provide their entire credit card number (See FIG. 3C). As an example, the system can use the source phone number of the text message from the user to identify the user, and then request that the user provide the last few digits of their credit card number to confirm their identity. Such an approach could be combined with a PIN (personal identification number) assignment as a further guarantee of customer security if required.

As suggested earlier, booking the service 240 with the service provider can be accomplished through a variety of means, such as through an electronic booking database, for example, although other approaches to booking the service 240 can be implemented that are known in the art. In one implementation, booking the service includes sending a booking text message to the service provider.

Booking the service 240 can include, for purposes of this application, 1) a confirmed booking with an appropriate credit guarantee, 2) a confirmed booking where the credit card is immediately charged and is cancellable, or 3) a confirmed booking where the credit card is immediately charged and is non-cancellable.

Booking the service 240 can trigger providing the user with “points” or “rewards” associated with booking such services consistent with various loyalty clubs and rewards organizations known in the art that are associated with providing incentive for users to use such services. A user who is a loyalty program member can enter their program number in a text message and the number can be parsed by the system. During the booking process, the program number is then communicated to the service provider. In at least one embodiment the program number can be used to identify the user to automatically book the service using credit cards and other personal information employed in the past.

Travel agent loyalty programs can also be supported by the system disclosed herein. In one implementation the mobile phone user can enter the booking handle of a travel agent. That participating agent can then earn points in their own loyalty program, and a portion of the commission can be split to the agency. Hence, travel agencies and travel agents can offer this system to their customers and earn points and commissions similar to bookings that they handle themselves.

In at least one embodiment, as mentioned above, an interactive voice recognition system can be incorporated in various steps of the method described herein to provide a variety of functions. For example, the interactive voice recognition can be used to interact with a user after an initial text message and automatically take responses, parse, or otherwise translate user responses into standard booking protocols in common use within the travel industry. A system incorporating interactive voice recognition can automate fill-in of reservation template for the user, which can then be used to book the service. Parsed data acquired through receiving a text message from a user can trigger an automatic call to the user's mobile phone with an interactive voice recognition system to, for example, confirm and book the service. The user can then supply their own name and credit card information as required to complete required fields of the reservation template. In this way the system enables the user to finalize the booking confirmation and complete the booking with a credit card guarantee or to purchase the service directly.

In one implementation of integrating interactive voice recognition into the system, the user uses their keypad of a mobile phone to type or say the following: their first and last name, credit card number, credit card expiration date and credit card security code if required. The interactive voice recognition system confirms the entry of each data type and validates the accuracy of the information with the user. The combined data acquired in the original text message and that acquired via text or phone at confirmation are merged into a unified hotel reservation booking confirmation data entry form which can meet a required format needed to issue booking confirmation from a service provider.

In one embodiment of the system that integrates interactive voice recognition, a user can request that the call be transferred to the hotel's reservation line by saying “Live Agent” or by keying in “0” on the phone key pad, for example. In one implementation, the system itself can also support a request for a live reservation agent call-back. For example, the user can issue the command “CB,” representing the words “call back,” and the system could automatically transfer the user's booking inquiry and request a call back from the service provider. Such information can be inserted in a text message, which can then automatically be converted to a voice message to connect with an agent of the service provider. If the user wants to simply call the line after performing a rate inquiry, a command would be supported wherein the traveler could simply query for the direct reservation line and would automatically receive a text message including such information. For example, the traveler could simply enter in a booking handle and issue a three-letter text message “DRL” (signifying a “direct reservation line”). The system can then text message back the direct reservation line phone number for that service provider.

The system can also assemble and send a booking confirmation via text to the customer from the service provider. The booking confirmation can be received by the system in a first format, and then convert the format of the booking confirmation to a second format to forward to the customer. The first format can be a voice response, for example, or Hyper Text Markup Language (HTML) link. The system can be configured to convert such data to the second format such as a text message, and then forward the text message to the customer.

Such a booking confirmation would forward on the service provider's confirmation number and confirm other pertinent details such as, in the case of a hotel confirmation—price, room, nights, and total charge. In such an embodiment the text confirmation may be converted from a voice message left by an agent of the service provider. In this embodiment the agent of the service provider may interact with an automated interactive voice recognition system to ensure the integrity of booking confirmation details.

FIG. 3B depicts a second example sub-method 240 of the method depicted in FIG. 2 in accordance with the technology disclosed herein. For purposes of this discussion, an offer can be a counteroffer.

After the system replies 230 to the mobile phone user, the mobile phone user has an opportunity to present an offered rate 311 in response to receiving a price. In such a scenario, the system then receives a text message from the mobile phone providing an offer 311, parses 313 the text message to retrieve counteroffer data, calculates the difference 315 between the offer rate and the lowest available rate, and determines a probability 321 corresponding to acceptance of the offer. The system then applies the probability 331 to arrive at an answer and replies with the answer 341. The system can then send booking information 351 to the service provider if the answer is affirmative or end 361 if the answer is negative. Another embodiment that would enable private offer/acceptance is to use text to voice technology which would allow the service provider's agent to accept or reject the customer's offer.

As indicated above in the discussion of FIG. 2, the reply to the mobile phone user 230 is generally in regard to price, and more particularly in regard to the best available rate of the service inquired about by the mobile phone user. In response, the user could, theoretically, provide any offer in response to the best available rate. Most often the user will provide an offer rate that is lower than the best available rate. The system receives the offer 311 and uses it to automatically determine whether the service provider will accept the offer rate.

After the message is received from the mobile phone, the system parsed the text message into at least an offer data field, wherein the offer data field is an offer rate for the service. The difference between the offer rate and a best available rate is calculated 315, which is used to determine a probability 321 that incorporates the difference between the offer rate and the best available rate. Generally, a particular embodiment of the system employs a stepped function based on the measured gap between lowest available rate and the offer rate to calculate the probability 321 of accepting the offer.

The offer is then accepted or declined by applying the probability 331 to a random binary decision to accept or decline the offer. For example, if the offer is equal to the best available rate communicated to the mobile phone user, there is a 100% probability that the offer will be accepted. So, the system would apply that probability to a random binary decision to accept the user's offer, and would arrive at “accept” based on the 100% probability.

When a user offers below the lowest available service rate, the probability will generally vary based on how far the lowest available service rate is from the offer rate. As the offer rate descends from the available service price, so will the probability that the offer rate will be accepted. In some embodiments, at a certain point below the offer the probability that the offer will be accepted can be zero. For example, if the offer rate is at least 50% below the offer rate, the system will reject the counteroffer. In another example, if the offer rate is at least 60% below the offer rate the system will reject the offer. Such probabilities can vary based on the needs of the particular service provider, or on other factors.

In a variety of implementations, the probability is determined by incorporating additional factors, such as the difference between a competitor rate and the best available rate. The competitor rate can be the lowest available rate of a competitor's service, whether the competitor's lowest available rate is lower than the service provider's lowest available rate, and/or the difference between the competitor's lowest available rate and the service provider's lowest available rate, where a competitor service provider is determined based on factors such as location, price-points, ratings, or other factors. For example, if a service provider has a higher lowest available rate than a competitor, it may be desirable to accept any counteroffer substantially equal to the competitor's best available rate, or at least increase the probability that such counteroffers will be accepted. The amount that such scenarios affect the probability of acceptance can be determined by industry standards, geographic location, or the service providers themselves. It is foreseeable that other factors would also impact the probability.

Once the probability is determined 321 it is then applied 331 to the binary random decision to either accept or decline the offer. The system once again replies to the user communicating the decision 341 to either accept or decline the offer, where the communication can be through a text message to the mobile phone. If the offer is accepted, the system sends booking information 351 to the service provider as described above, for example, in the discussion of FIG. 3A. If the offer is rejected, the system can end 361 the method. In another embodiment, if the offer is rejected, the system can send a reply re-proposing the lowest available service rate to the mobile phone user.

The system can also be configured to accommodate other responses by users through text message. For example, a user may send a request via text message for room details, refining an inquiry by providing a rate category (such as AAA for users who qualify for American Automotive Association discounts), providing a loyalty program number, group booking number and/or identification number, providing for a radius of a specific location, providing for specific service provider or all competitive service provider within a particular radius of a particular location (airport, downtown, specific address, specific service provider, and the like).

In at least one embodiment, the offer presented by the mobile phone user through text message is provided through the initial text message initiating a search. In such an embodiment, the text message can be parsed into at least the offer data field, a first data field, and a second data field, wherein the first data field is a start date for a service and the second data field is the end date for the service. A service provider booking handle can also be provided. A location can also be provided. Data from at least the first data field to a search engine to search for the best available rate, although in a variety of embodiments, data including service provider name, location, and service dates will also be communicated to a search engine.

FIG. 3C depicts a third example sub-method of the method depicted in FIG. 2 in accordance with the technology disclosed herein. As discussed in the discussion of FIG. 2, above, the reply 230 to the mobile phone user can include communication to the mobile phone user regarding availability and price, and could include availability information based on the service provider most recently booked through the system for that particular user.

The system receives a text message from the mobile phone containing a personal identification number (PIN) 312, and searches a customer database 322. The information retrieved from the customer database is used to book the service 332. The PIN can have a variety of configurations, and is generally used to confirm identification of an individual who has previously used the system from a particular phone number. The PIN can be a number chosen by the user, taken from the last four digits of the user's credit card, incorporate the user's phone number, and so on.

The system then searches a customer database 322, where the customer database contains information associated with users who have previously used the system or who have set up accounts with the system previously. In at least one embodiment, the system uses the user-provided PIN in addition to the user phone number to identify and confirm the identity of the particular user. Customer information associated with the phone number and PIN can then be used to send booking information 332 to the service provider. As such, receiving a PIN 312 is essentially interpreted by the system as confirmation of booking details presented in the system reply to the user.

In another embodiment, the system receiving the PIN 312 with an additional command such as “book” or “yes” or “OK” triggers the system to send booking information 332 to the service provider. In another embodiment, the system receiving the PIN 312 causes the system to send booking information 332 to the service provider last used by the mobile phone user unless the mobile phone user includes an additional command, such as a command associated with a counteroffer, a service provider search, or any other command.

Sending booking information 332 to the service provider is then accomplished through any of the means and methods previously described. Sending the booking information 332 to the service provider or intermediary causes the service to be booked. Confirmation of the booked service is then sent to the mobile phone user through a text message, e-mail, or other means.

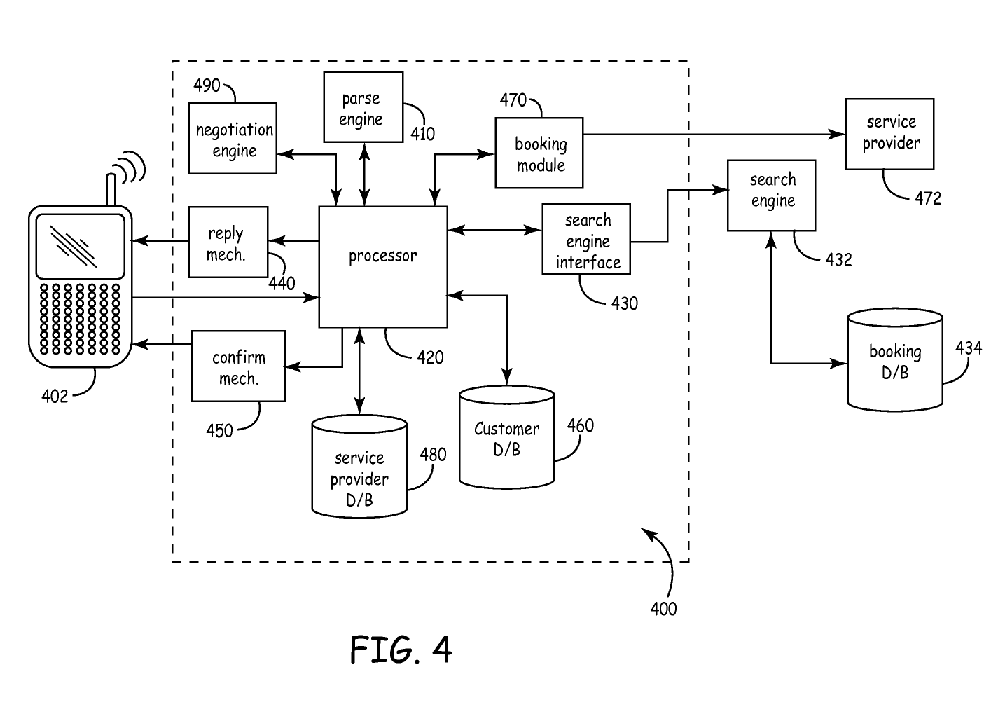

FIG. 4 depicts an example system in accordance with the technology disclosed herein. The booking system 400 generally has a text parse engine 410, a processor 420, search engine interface 430 in communication with a search engine 432, reply mechanism 440, a confirmation mechanism 450, a customer database 460, booking module 470 in communication with a booking database 434 via a search engine 432, a service provider database 480, and a negotiation engine 490. The booking system 400 is in communication with a mobile phone 402 operated by a mobile phone user. The system 400 can be incorporated in a variety of web-enabled database systems including, for example, SQL/XML database systems. The current system can be compliant and integrated into the Open Travel Alliance specifications, proprietary systems, and/or direct to the hotel via front office systems.

The text parse engine 410 is configured to receive a text message containing information related to a desired reservation and parse the text message into a plurality of fields. The plurality of fields can include at least a start date field, an end date field, and a location field. The plurality of fields could also include at least a start date field, an end date field, and a booking handle representing a particular service provider. The particular service provider can be a preferred service provider, a favorite service provider, or the desired service provider. The text parse engine 410 is in communication with the processor 420, and the processor 420 can format and provide such information to other components of the system 400 such as the search engine interface 430.

The processor 420 is in communication with virtually all of the components of the system 400, either directly or indirectly, and communicates data between system 400 components. For example, the processor 420 is in communication with the text parse engine 410 and the search engine interface 430 to communicate a search request received from the mobile phone 402 to one or more search engines 432. Generally the processor 420 is configured to format a reply to a text message from the mobile phone 402 with information related to at least one of the available reservations acquired from the search engine interface 430. The processor 420 acquires data from the service provider database 480 and communicates such data to the search engine interface 430.

The service provider database 480 of the system 400 is generally consistent with the service provider database depicted in FIG. 1 and described in the text associated therewith. The service provider database 480 can include service provider data including a booking handle as described in the discussion of FIG. 1, name, location, contact information such as a phone number, ratings associated with the service provider, and the like.

The search engine interface 430 is configured to receive data from the text parse 410 engine and be in communication with a booking database 474 reflecting available reservations. The search engine interface 430 will generally be in communication with one or more search engines 432, wherein at least one of the one or more search engines 432 are configured to search at least the booking database 434. The search engine interface 430 can be configured to communicate the data to one or more search engines 432.

Because the system disclosed herein can be coupled with a variety of systems and search engines 432, it can be desirable to convert data understood by the system to data that will be understood by the one or more search engines 432. As such, the search engine interface 430 is in communication with a search engine 432, and is configured to provide and/or format the search engine with useable data. For example, one or more search engines 432 will not necessarily recognize the booking handle associated with a service provider as useable data. So the search engine interface 430 and the processor 420 communicate to provide the search engine 432 with service provider information from the service provider database 480 based on search data obtained from the test parse engine 410 which ultimately was received from the mobile phone 402.

Likewise, the search engine interface 430 receives information from the booking database 434. Such information can be received directly from the one or more search engines 432, and includes results from a search. The search engine interface 430 can convert data reflected in results from a search to data recognized by the system such as converting a service provider name to a booking handle. Other conversions can be necessary, such as the specific format of the data, for example. The search engine interface 430 sends such formatted data to the processor 420 to be used by the system 400.

The one or more search engines 432 can generally be any search engine capable of searching one or more booking databases 434. The search engines 432 generally conduct a search based on a mobile phone users request for a service associated with particular dates or times, such as a start time and end time or a start date and an end date, and a particular service provider. The search engine interface 430 provides the search engine 432 with such data, and the search engine is instructed to search. The search engine interface 430 can also send data to the search engine providing a search for the best available rate among competitor service providers within a particular radius of the particular service provider, where competitor service providers can be determined based on similarity to the particular service provider such as through ratings, prices, location, and the like. In one embodiment, a particular radius around the particular service provider is searched for the best available rate.

The reply mechanism 440 is in communication with the processor 420 and provides text messages to the mobile phone 402 in response to text messages received from the mobile phone 402. The reply mechanism 440 can provide a text message to the mobile phone 402 regarding results of a search engine search, for example. Generally the reply mechanism 440 will provide the best available rate for a service from a particular service provider, where the particular service provider can be a favorite service provider, or the particular service provider can be the service provider with the best available rate.

The reply mechanism 440 can also provide the best available rate of a favorite service provider in addition to the best available rate of a competitor service provider, where the competitor service provider is chosen based on similarity to the favorite service provider, such as through ratings, prices, and location. The reply mechanism 440 can also provide the mobile phone user with text messages containing further data requested by the mobile phone user through a text message from the mobile phone 402. For example, the reply mechanism can provide extended service provide details. A request from the mobile phone can be made through a request code, for example. The reply mechanism can also include information relevant to a price negotiation with the mobile phone user, which will be described in more detail in the discussion of the negotiation engine 490, below.

The system includes a customer database 460 having customer information. Such database is in communication with the processor such that customer information can be accessed for booking a service. Customer information can include customer name, PIN, password, credit card number, billing address, e-mail, phone number, alternative phone number, one or more favorite hotels, recently booked services, recently used services, and the like. The processor 420 can be in communication with the customer database 460 to provide customer information to the booking module 470, for example.

The confirmation mechanism 450 is generally configured to confirm mobile phone user identity based on data contained in the customer database 460. This may be accomplished through, as described above, receiving a PIN from the mobile phone 402 and identifying the mobile phone number of the initiating text message from the mobile phone 402. The confirmation mechanism 450 then communicates the intention to book the service to the processor 420. At that point the processor 420 can initiate the booking module 470 to book the service with a service provider 472.

The booking module 470 is configured to book the service and is generally in communication with one or more service providers 472. The processor 420 can provide the booking module 470 with service provider information, such as phone number, such that the booking module 470 contacts the service provider 472 to book the service. The booking module 472 can provide a text message to the service provider in one embodiment, where the text message includes booking information such as dates/times, mobile phone user billing information, and mobile phone user contact information.

In another embodiment, where the service provider may not be equipped to receive text messages, the booking module 470 can incorporate Interactive Voice Recognition technology and convert the text message to a voice message. In yet another embodiment, the booking module can provide the service provider with the mobile phone user's contact information such that the mobile phone user can provide booking data over the phone and to a live agent of the service provider.

In some embodiments, the search engine that is utilized may be capable of performing booking operations. As such, the booking module 470 can be configured to provide the search engine with booking data to book the service.

The parse engine 410 can receive a counteroffer through a text message from the mobile phone 402, and the processor 420 communicates that particular data to the negotiation engine 490. The negotiation engine 490 is in communication with the processor 420 and is generally configured to randomly accept and decline counteroffers based on a probability determined from the difference between the counteroffer rate and a lowest available rate. As the gap between the counteroffer rate and the lowest available rate widens, the probability that the counteroffer will be accepted goes down. The determination of the probability of the counter offer being accepted can be based on a stepped function in a variety of embodiments, where each “step” represents a range of the difference between the lowest available rate and the counteroffer rate.

The negotiation engine 490 can also be configured to accept and decline offers based on the probability determined from the difference between the offer rate and the lowest available rate and the difference between the lowest available rate and the lowest available competitor rate. If the lowest available competitor rate is lower than the lowest available rate, then the probability that the counteroffer will be accepted is increased when the counteroffer is substantially equal to, or above, the lowest available competitor rate.

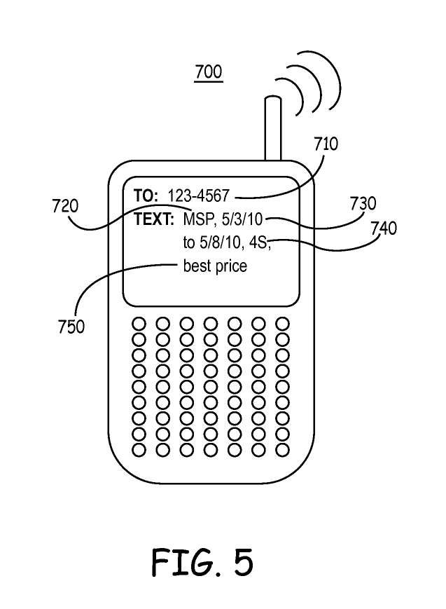

FIG. 5 depicts an example implementation of the technology disclosed herein. A mobile phone 700 is used to communicate with the technology described herein to book a service according to the mobile phone user's needs. The mobile phone 700 display provides example language that can be communicated to the system to initiate a search for the best available rate of a service, such as booking a hotel room.

The “To” line 710 reflects the phone number to which the text message is being sent. In other words, the text message is sent to a phone number associated with the system described herein. In the text message itself, the user can communicate the location 720, which is represented by an airport code in this embodiment, although other ways of communicating a geographic location can be used. Service dates 730 include a start date to an end date, and communicate when the service should be booked. In an embodiment where the service is a hotel room booking, the start date would be a check-in date and the end date would be a check-out date.

The service providers can be characterized in a variety of classifications. In embodiments where the service providers are hotels, the hotels can be classified according to their star-rating, as is known in the art. In FIG. 5, the mobile phone user has entered in data communicating that the service provider should have at least a 4-star rating. The request for a 4-star rating can also be demonstrated by alternate abbreviations and symbols, as will be appreciated.

Finally, the system user has indicated that they are most interested in the best available rate. In a variety of embodiments, a system user can indicate other relative preferences, such as a particular service provider or a location. As has been described herein, the user can also include an offer rate. The user can also include a request to speak with a representative of a service provider.

Other abbreviations can be recognized by the system as a means of shortening and simplifying the process of using the system and/or sending text messages to the system. Such abbreviations can be provided to potential system users in advance of using the system. In another embodiment such abbreviations can be provided to system users during use of the system through coaching, e-mail, or text messages in response to a request for help.

It should also be noted that, as used in this specification and the appended claims, the phrase “configured” describes a system, apparatus, or other structure that is constructed or configured to perform a particular task or adopt a particular configuration. The phrase “configured” can be used interchangeably with other similar phrases such as “arranged”, “arranged and configured”, “constructed and arranged”, “constructed”, “manufactured and arranged”, and the like.

All publications and patent applications in this specification are indicative of the level of ordinary skill in the art to which this invention pertains. All publications and patent applications are herein incorporated by reference to the same extent as if each individual publication or patent application was specifically and individually indicated by reference.

This application is intended to cover adaptations or variations of the present subject matter. It is to be understood that the above description is intended to be illustrative, and not restrictive.

We claim:

1. A booking system comprising:
a text parse engine configured to receive a text message containing information related to a desired reservation and parse the text message into a plurality of fields;
a search engine interface configured to receive data from the text parse engine and be in communication with a booking database reflecting available reservations; and
a processor in communication with the text parse engine and the search engine interface, wherein the processor is configured to reply to the text message with information related to one of the available reservations.

2. The system of claim 1 wherein the plurality of fields include at least a start date field, an end date field, and a location field.

3. The system of claim 1 further comprising a negotiation engine in communication with the processor.

4. The system of claim 3, wherein the negotiation engine is configured to accept and decline offers based on a probability determined from the difference between an offer rate and a lowest available rate.

5. The system of claim 4, wherein the negotiation engine is further configured to accept and decline offers based on the probability determined from:
the difference between the offer rate and the lowest available rate; and
the difference between the lowest available rate and the lowest available competitor rate.

6. The system of claim 1 further comprising one or more search engines in communication with the search engine interface, wherein at least one of the one or more search engines are configured to search at least the booking database.

7. The system of claim 1 wherein the search engine interface is configured to communicate the data to a search engine.

8. The system of claim 1 further comprising a customer database having customer information in communication with the processor.

9. The system of claim 1, further comprising a mobile phone device, configured to send a text message to the text parse engine.

10. A method of booking a reservation for a service comprising:
receiving a text message from a mobile phone;
parsing the text message into at least a first data field and a second data field, wherein the first data field is a start date for the service, and the second data field is an end date for the service; and
booking the service from the start date to the end date.

11. The method of claim 10 further comprising determining availability of a service based on the first data field and the second data field.

12. The method of claim 10 further comprising parsing the text message into a third data field wherein the third data field represents a location.

13. The method of claim 12, wherein the third data field is a booking handle maintained by the system and published and made available to users.

14. The method of claim 12, wherein the third data field comprises one or more of the following:
postal address, street intersection and zip-code.

15. The method of claim 10 wherein the step of booking the service further comprises using information from a previously-booked service.

16. The method of claim 15 wherein the information from a previously-booked service is chosen from the group consisting of: credit card information, service provider information, and service information.

17. The method of claim 10 further comprising sending a text message to the mobile phone including price information.

18. The method of claim 10 further comprising receiving a text message from the mobile phone confirming booking the service.

19. The method of claim 10 further comprising sending a booking text message to the service provider.

20. The method of claim 19, wherein sending the booking text message to the service provider further comprises converting the booking text message to a voice message.

21. The method of claim 19, further comprising receiving a booking confirmation from the service provider in a first format, wherein the system converts the booking confirmation to a text message and forwards the confirmation text message to the customer.

22. The method of claim 10 further comprising receiving a text message from the mobile phone providing a counter-offer.

23. The method of claim 10 further comprising receiving a text message from the mobile phone providing an identification number.

24. The method of claim 10 further comprising receiving a text message from the mobile phone providing a request to connect the mobile phone with the agent.

25. A method of negotiating a rate comprising:
receiving a text message from a mobile phone;
parsing the text message into at least an offer data field, wherein the offer data field is an offer rate for a service;
calculating the difference between the offer rate and a best available rate;
determining a probability incorporating the difference between the offer rate and the best available rate;
applying the probability to a decision to accept or decline the offer rate; and
sending a text message response reflecting the decision to the mobile phone.

26. The method of claim 25, wherein determining a probability further comprises incorporating the difference between a competitor rate and the best available rate.

27. The method of claim 25, further comprising parsing the text message into at least the offer data field, a first data field, and a second data field, wherein the first data field is a start date for a service and the second data field is the end date for the service.

28. The method of claim 27 further comprising sending data from at least the first data field to a search engine to search for the best available rate.
